(19) United States
(12) Patent Application Publication
(10) Pub. No.: US 2004/0130087 A1
(43) Pub. Date: Jul. 8, 2004

(54) Apparatus for securing stacks of sheet-shaped materials for rotary movement

(76) Inventors: Alexander Hirsch, Kirchheim (DE); Peter Staudt, Drackenstein (DE); Harald Mauz, Ehingen (DE); Albert Rieger, Geislingen (DE); Hans-Peter Wurschum, Ostfildern (DE)

Correspondence Address: Richard A. Romanchik, Heidelberg Digital L.L.C., 2600 Manitou Road, Rochester, NY, 14624, US

(21) Appl. No.: 10/673,616

(22) Filed: Sep. 29, 2003

(30) Foreign Application Priority Data
Oct. 2, 2002 (DE) 102 46 077.9
Oct. 2, 2002 (DE) 102 46 076.0

(51) Int. Cl. B42B 2/00

(52) U.S. Cl. 270/52.18

(57) ABSTRACT

The present invention relates to an apparatus (100) for securing stacks of sheet-shaped materials during a rotary movement, whereby the rotation occurs around an axis of rotation (M) that is parallel to the outside edges of the sheet-shaped materials, with a first and a second clamping jaw (10, 11) that has a drive, whereby the an apparatus is mounted in such a way that the rotation can be carried out in an angular range of essentially 360°.

### RELATED APPLICATIONS

The following co-pending and commonly assigned U.S. patent applications relate to and further describe other aspects of the embodiments disclosed in this application and are incorporated by reference in their entirety.

U.S. patent application filed coincidentally with the present application entitled “Device for Securing Stacks of Sheet-Shaped Materials during a Rotary Movement”, U.S. application Ser. No. ______, which said application claims the benefit of German application serial number 102 46 076.0 filed Oct. 2, 2002, and which is hereby incorporated by reference in it's entirety.

### FIELD OF THE INVENTION

The invention relates to a An apparatus for securing stacks of sheet-shaped materials during a rotary movement, whereby the rotation occurs around an axis of rotation that is parallel to the outside edges.

### BACKGROUND

Machines are used in the print industry to move stacks of sheet-shaped materials that will be bound, or are already bound, from one processing station to the next or to stack them on a tray. It is important that the sheet-shaped materials in the stack do not lose their alignment with respect to each other to prevent errors from occurring during the outside edge processing of the stack of sheet-shaped materials. For instance, punched holes, e.g. for a wire comb binding, plastic comb binding or spiral binding, can slip, which leads to later problems when attempting to thread corresponding binding elements through the holes. On the other hand, stacks of sheet-shaped materials that are already bound will be transported to a delivery point without the outside edges of the sheet-shaped materials in the stack becoming displaced with respect to each other, in order to facilitate stacking at the delivery point or to minimize the stress of binding to prevent damage to the bound brochures or the bound book.

A number of apparatuses for transporting and turning book blocks are known from the state of the art. European Patent Application EP 1 122 198 A2 shows e.g. a turning an apparatus for book blocks. In this process, a book block is transported between two endless transport belts that are mounted on a turning unit. As soon as the book block is located completely between the two endless transport belts, the book block is secured in this position, the entire turning an apparatus is rotated 180°, the book block is released again and transported further. However, the apparatus shown there is not especially suitable for unbound stacks of sheet-shaped materials since the book block must first go up an incline between two transport bands. In this case, the axis of rotation is parallel to the outside edges of the pages of the book block.

Spatial and energy requirements of the individual components of a processing an apparatus may play a critical role. A transport apparatus for stacks of sheet-shaped materials or book blocks takes up space within an apparatus which cannot be used simultaneously by other units within the apparatus, since this may result in a conflict situation between a stack of sheet-shaped materials that is passing by and the transport an apparatus holding them, unless there is a complicated synchronizing of the units that use the same space.

Rotation of a stack of sheet-shaped materials is usually especially complicated because the stack of sheet-shaped materials is exposed to torques, thereby requiring the individual sheet-shaped materials receive adequate protection against slipping. In addition, turning and transporting stacks of sheet-shaped materials generally have a relatively large space requirement, and for combined movements the space requirement increases still more. In book binding production lines, this may be no problem, but on the other hand it would be a problem in digital printing applications, in which frequently the number of copies is low and correspondingly small machines are used for binding.

European patent EP 790 139 B1 shows another apparatus for transporting and rotating stacks of sheet-shaped materials. In this case, tongs with extended clamping plates mounted on an arm so that they can rotate are disclosed. The tongs swivel a collected stack of sheet-shaped materials from a horizontal position at the collecting location into a vertical position in the area of a downstream apparatus. Although the stack of sheet-shaped materials is turned 90°, a swiveling movement takes place instead of a simple rotation. It can be seen that the space required for this movement is considerable.

An apparatus for transferring book blocks to the transport means of a book binding machine is disclosed in the German OLS DE 34 13 222. In this case, a stack of sheet-shaped materials is collected horizontally into a book block and then, using a clamp with positive action, is introduced into the transport means of a book binding machine. In this process, during the forward movement, the clamp swivels the book block from the horizontal to the vertical.

In other applications it is necessary to place bound printed products in stacks. With bindings that have a considerably greater expansion in comparison to the thickness of the stack, (e.g. by using wire comb binding or spiral binding of bound brochures) it is necessary to stack the spines of such brochures alternating on different sides and offset with respect to each other within a stack of such brochures, since this is the only way to ensure that the stack is straight.

### BRIEF DESCRIPTION OF THE DRAWINGS

FIG. 1 is a schematic three-dimensional view of the apparatus according to the invention.

FIG. 2 is a schematic top view of the apparatus according to the invention.

FIG. 3 is a schematic view of the apparatus according to the invention.

FIG. 4 is a schematic representation of a higher-level device for transporting the stack of sheet-shaped materials according to the invention.

### DETAILED DESCRIPTION

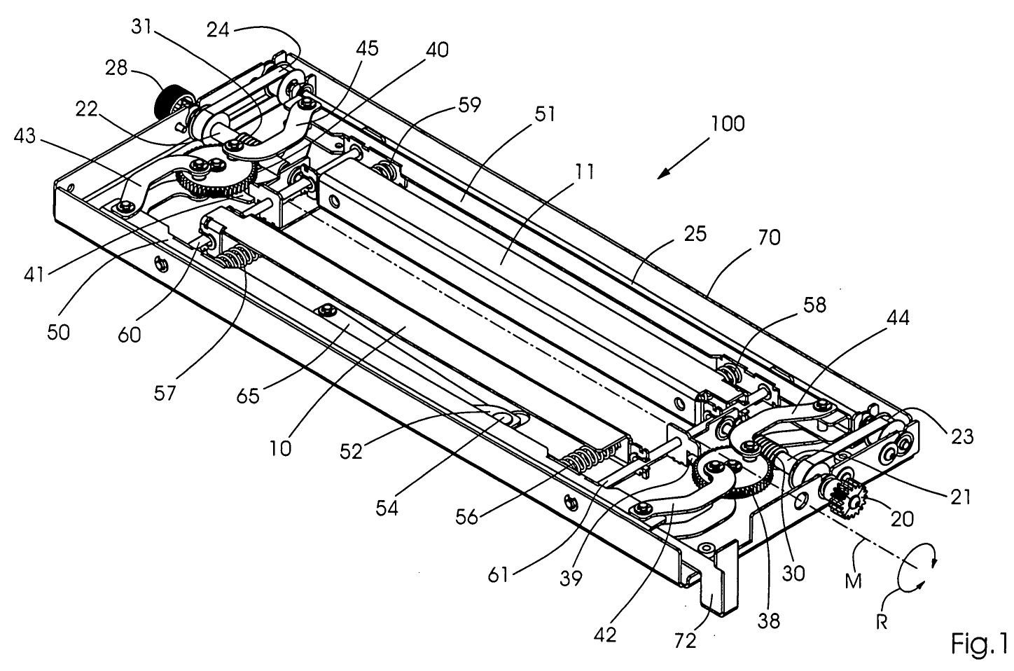

FIG. 1 shows the overall structure of a an apparatus 100 according to the invention. Other generally known drive and/or guide means and cams required for operation of the apparatus are shown only schematically and/or only described in a general way.

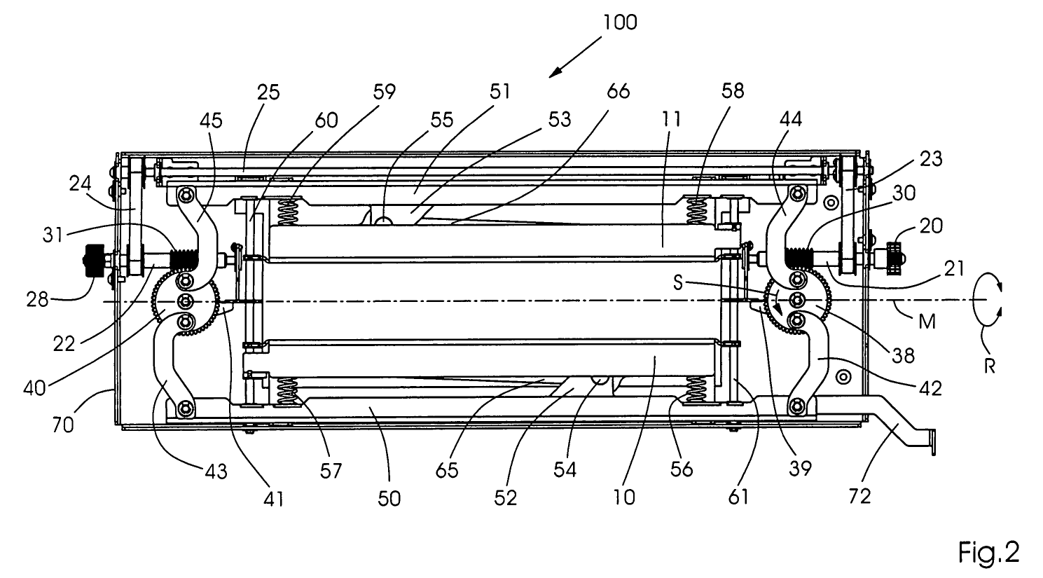

In FIGS. 1 and 2, an apparatus 100 has clamping jaws 10 and 11 mounted within. The drive of the clamping movement is derived from a motor, such as a stepper motor known to the person skilled in the art, which drives a first gear 20 mounted on a first shaft 21. During a rotation of the apparatus 100 around the center line of a stack of sheet-shaped materials shown in dotted lines and identified with reference character M in a direction of rotation marked with double arrow R, a drive gear remains continuously engaged with the first gear 20. The center line M of the stack of sheet-shaped materials also marks half the distance between the maximum opening of clamping jaws 10, 11.

By way of a first pulley 23, a third shaft 25 and a second pulley 24, a second shaft 22 is driven. Alternatively, gears and toothed belts that engage each other or other transmission means known to the person skilled in the art for a rotary drive movement may be used.

The first shaft 21 and the second shaft 22 have the same axis. The first shaft 21 and the second shaft 22 both have worms 30, 31 that are each engaged with a worm gear 38, 40. Two connecting rods 42, 43, 44, 45 are mounted on worm gears 38, 40 eccentrically and with point symmetry so that they can move. As can be seen in FIG. 1, the connecting rods 42, 43, 44, 45 are double connecting rods that each have a connecting element above and a connecting element below the worm gear 38, 40.

The worm gears 38, 40 have an axis of rotation that crosses the center line M of the stack of sheet-shaped materials. Because of this, symmetrical movement of the clamping jaws 10, 11 relative to center line M is achieved. In an open state, the connecting rods 42, 43, 44, 45 are each mounted in the slack points of the worm gears 38, 40. The stop elements 39, 41 that are each mounted at the worm gears 38, 40 prevent the connecting rods 42, 43, 44, 45 from rotating beyond the slack points 38, 40 when the clamping jaws 10, 11 are opened. The connecting rods 42, 43, 44, 45 are mounted in pairs at the ends of pressure pads 50, 51 so that they can move. The pressure pads 50, 51 are mounted in longitudinal guides 60, 61. In addition, the pressure pads 50, 51 have tabs 52, 53 that are each connected by way of a connecting element 54, 55 respectively with a linkage rod 65, 66 with the clamping jaws 10, 11.

A movement of the pressure pads 50, 51 along the longitudinal guides 60, 61 is transferred in each case by two pressure springs 56, 57, 58, 59 to clamping jaws 10, 11.

If a stack of sheet-shaped materials is located, centered, between the open clamping jaws 10, 11, the drive synchronously drives both worm gears 38, 40 in a direction of rotation marked with the reference character S so that the worm gears 38, 40 simultaneously carry out a movement of 180°. Connecting rods 42, 43, 44, 45 have a sickle-shaped form so that a rotation of 180° is possible. When clamping jaws 10, 11 come into contact with the stack of sheet-shaped materials (because of the movement of connecting rods 42, 43, 44, 45 and the associated movement of pressure pads 50, 51 along longitudinal guides 60, 61), further rotation of the worm gears 38, 40 cause the pressure springs 56, 57, 58, 59 to be pressed together and, because of the tension that develops thereby in the pressure springs 56, 57, 58, 59, a holding force is applied that is necessary to securely hold the sheet-shaped materials within the stack.

Outside the housing 70, the second shaft 22 has a hand wheel 28 with which the shaft 22 can be rotated manually, and by way of the coupling 24, 25, 23, the first shaft 21 can also be rotated. In this way, the worm gears 38, 40 and correspondingly the clamping jaws 10, 11 can be opened and closed in manual operation. Because of the high reduction ratio of the worm gear transmission, self-locking (for protection against losing a paper stack due to power failure) is achieved.

On one end, the first pressure pad 50 has a lug 72 that extends out of housing 70. The lug 72 is recognized by an external sensor (not shown) whereby a higher level control receives information about the position of pressure pads 50, 51 and thus about the opening state of the apparatus 100.

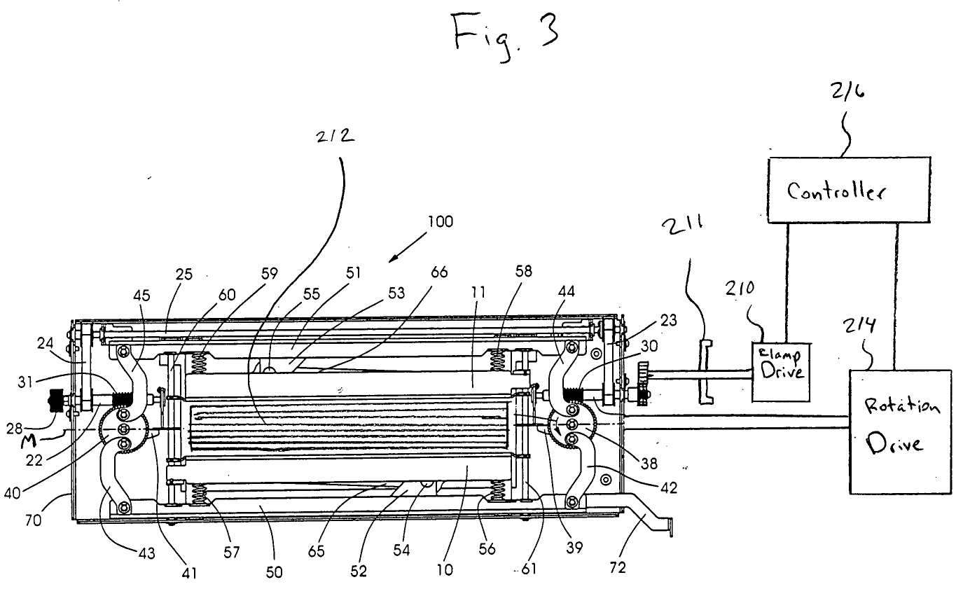

Referring now to FIG. 3, clamping jaws 10, 11 are driven by a clamp drive 210 to clamp a stack 212 of sheet-shaped materials. Once adequately clamped, the device 100 and stack 212 are rotated about the centerline M by a rotation drive 214. Drive 214 has the ability to rotate the stack in either direction 360°. The clamp drive 210 and the rotation drive 214 are controlled by a controller 216. The clamping jaws 10, 11 may be operated by a hand drive 211 (e.g. a wheel).

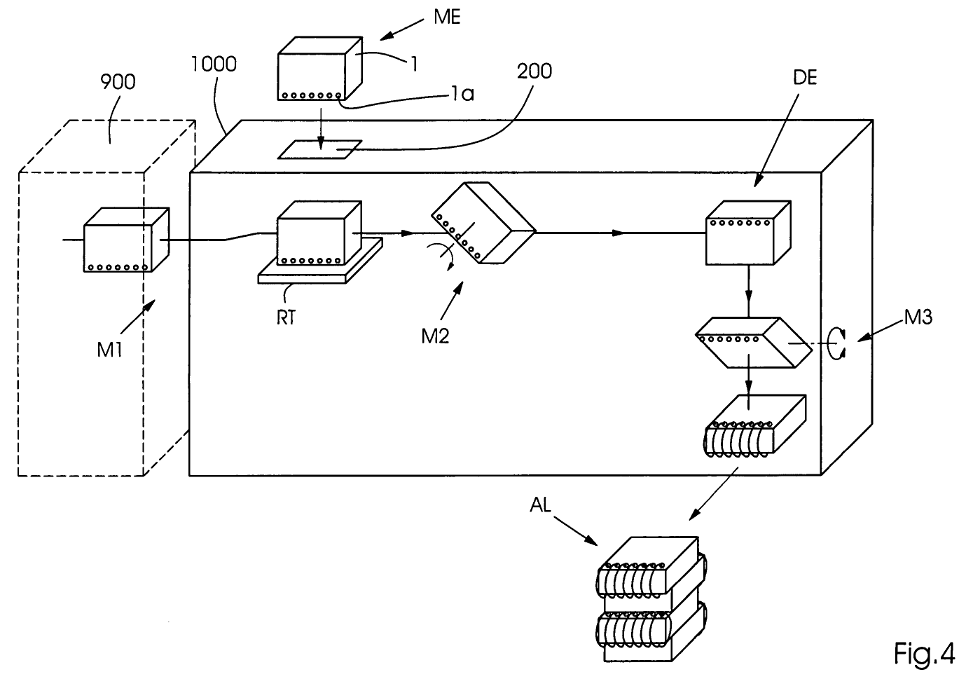

FIG. 4 shows a device 1000 in which the device 100 according to the invention is used. The device 1000 is a device with a transport system for stacks of sheet-shaped materials 1, especially a device for binding stacks of sheet-shaped materials 1. Binding may involve glued bindings, spiral bindings, plastic comb bindings or other bindings; binding with a wire comb binding element is especially preferred.

The sheet-shaped materials may already have been prepared for binding. This means that, in the case of a glued binding, the sheet-shaped materials have page edges that are already trimmed and/or roughened and/or notched that form the book spine. In the case of spiral, plastic comb or wire comb binding, the sheet-shaped materials have a row of perforations 1a that are aligned with respect to each other, into which a corresponding binding element can be inserted. Depending on the application, preparatory treatment such as this of the page edges of the sheet-shaped materials or of the stack of sheet-shaped materials 1 may not be carried out until they are within the device 1000.

A stack of sheet-shaped materials 1 (212 in FIG. 3) is accepted by a first transport unit M1 from a device 900 mounted upstream and transported to the inside of the device 1000. The device 900 mounted upstream can be, in particular, a device for collecting sheet-shaped materials into stacks 1. In an embodiment of the first transport unit M1, this stack of sheet-shaped materials 1 is made available in a vertical alignment. When the transport unit M1 moves in, advantageously the stack of sheet-shaped materials 1 is aligned to its center line with respect to stack thickness D.

Alternatively, the device 1000 can also have an opening 200, through which manual insertion of a stack of sheet-shaped materials 1 is possible. In this case, the first transport unit M1 serves to prevent fanning of the sheet-shaped materials above a vibrating table RT, by means of which the sheet-shaped materials in stack 1 are aligned against a stop (not shown).

In an embodiment, the first transport unit M1 has a thickness meter, by means of which the stack thickness D of the respective stack of sheet-shaped materials 1 is determined. This information is made available to a controller 216 which uses this information for purposes such as to request a binding element adjusted to stack thickness D for binding the stack of sheet-shaped materials 1.

A second transport unit M2 transports the stack of sheet-shaped materials 1, aligned centrally with respect to the stack thickness, to a binding unit DE, whereby the stack of sheet-shaped materials 1 is rotated 180° around an axis of rotation that is normal to the sheet-shaped materials and transfers the stack to a third transport unit M3.

In the binding unit DE, the stack of sheet-shaped materials 1 is bound while it is held by the third transport unit M3. After that, the third transport unit M3 transports the stack of sheet-shaped materials 1 to a tray and, to achieve better stack formation, optionally rotates the stack of sheet-shaped materials 1, especially alternating, around an axis of rotation that is parallel to the outside edges of the stack of sheet-shaped materials 1.

In an embodiment of the apparatus according to the invention, during closing and opening the clamping jaws carry out a movement that is symmetrical to the stack of sheet-shaped materials in order to secure the stack of sheet-shaped materials. A movement of this type is especially advantageous if the center of the stack thickness of the stack of sheet-shaped materials coincides with the center of the space between the two clamping jaws in their initial positions. Still more advantageously, the two clamping jaws are both driven so that they can both be moved away from or toward the stack of sheet-shaped materials. It is especially advantageous if the two clamping jaws have a common drive. An alignment of the stack of sheet-shaped materials with respect to its center can thus be achieved and/or maintained reliably and simply.

In another embodiment of the apparatus according to the invention, the stack of sheet-shaped materials is located vertically between the clamping jaws when being received by the apparatus. This represents a special demand on the holding force of the clamping jaws, since these must hold the stack of sheet-shaped materials in such a way that the vertical alignment of the stack does not lead to a displacement of the sheet-shaped materials within the stack.

In another embodiment of the apparatus according to the invention, the drive for the clamping jaws is not moved. In this way, the mass that has to be rotated can be decreased. Also, when electric drives, e.g. stepper motors are used, the cable routing can be made simpler.

In another embodiment of the apparatus according to the invention, the apparatus is closed on both sides. In this way, it is easier to achieve a more stable structure. For instance, the lateral introduction into a stack of sheet-shaped materials becomes very difficult. In the case of where the apparatus according to the invention holds a stack of sheet-shaped materials hanging vertically and transports them vertically downward and turns them by either +90 degrees or −90 degrees the stack turned 90 degrees can be transported with a conveyor belt out of the area of the an apparatus in a simple manner.

In another embodiment of the apparatus according to the invention, the drive drives two worm gears, whereby the worm gears translate the rotary movement of the drive into a linear movement. The worm gears represent an especially favorable embodiment for translating the rotary movement of the drive into a clamping movement of the clamping jaws, especially if the clamping movement has its end point in the area of the slack points of the worm gears. In the area of the slack points, the worms that turn the worm gears carry out a relatively large number of rotations, but this only leads to a small lateral movement of eccentric connecting rods that are mounted on the worm gears. In this way, a drive can apply a relatively large force in the area of the slack points, especially the large holding force required to secure the sheet-shaped materials. In addition, because of the high ratio on the worm gear transmission, there is a considerable self-locking of the worm gear when it is off-circuit. Because of this, the clamping jaws securely clamp the stack of sheet-shaped materials even if there is a power failure.

In another embodiment of the apparatus according to the invention, the closing movement is independent of the thickness of the stack. The clamping jaws are pressed against the stack of sheet-shaped materials by the drive by way of pressure springs. In this way, the clamping jaws are automatically pressed more firmly against the stack of sheet-shaped material with increasing stack thickness increases because of the same regulating distance of the clamping jaws.

In another embodiment of the apparatus according to the invention, the clamping jaws are mounted so that they float in order to compensate variations in thickness within the stack of sheet-shaped materials. Thickness variations of this type can occur if the sheet-shaped materials in the stack have been printed differently, i.e. the toner application varies greatly along the clamping jaws. Because of pressure springs that are mounted on the outer ends of the clamping jaws, it is possible to distribute the holding force of the clamping jaws uniformly along the clamping jaws. In addition, the clamping jaws advantageously have longitudinal guides that ensure an essentially straight-line movement of the clamping jaws. The clamping jaws extend over the entire length of the sheet-shaped materials in order to obtain the greatest possible holding surface and thus the most uniform possible holding force along the stack of sheet-shaped materials.

In another embodiment of the apparatus according to the invention, the axis of rotation lies essentially in the center of the stack. In this case, the center of the stack is understood to mean the plane that is at half the stack thickness. The axis of rotation lies within the stack. In this way, the torque to be applied for rotation of the stack of sheet-shaped materials can be kept as low as possible. In a preferred embodiment it also has a structure that is essentially symmetrical to the center of the stack so that the center of gravity of the apparatus also lies close to the axis of rotation. Because of this, the torque required for rotation of the apparatus is also reduced. Another advantage that results because of this is that the axis of rotation lies in the center of the stack and within the stack such that variations in the stack thickness, and thus variations in the masses to be rotated, cause only slight changes in the torque to be applied. Especially advantageously, the center of gravity of the stack and/or of the apparatus according to the invention lies in the axis of rotation or close to the axis of rotation.

In another embodiment of the apparatus according to the invention, the movement of the clamping jaws can also be operated manually using a hand wheel for maintenance or cleaning.

1. An apparatus for securing sheet-shaped materials during a rotary movement, whereby the rotation occurs around an axis of rotation (M) that is parallel to the outside edges of the sheet-shaped materials comprising:
first and a second movable clamping jaws;
a clamp drive for driving the first and second clamping jaws to clamp the sheet-shaped materials;
a rotation drive for rotating the clamped stack of sheet-shaped materials around the axis of rotation (M), wherein the axis of rotation is on the centerline of the clamped stack of sheet-shaped materials.

2. An apparatus according to claim 1, wherein driving of the first and a second movable clamping jaws is carried out symmetrical to the stack of sheet-shaped materials.

3. An apparatus according to claim 1, wherein the stack of sheet-shaped materials is arranged vertically while being clamped.

4. An apparatus according to claim 1, wherein the clamp drive does not move the first and a second movable clamping jaws during the rotation.

5. An apparatus according to claim 1, wherein the first and a second movable clamping jaws are closed on both sides.

6. An apparatus according to claim 1, wherein the clamp drive drives two worm gears that translate rotary movement of the clamp drive into a linear movement.

7. An apparatus according to claim 1, wherein the clamping movement of the first and second clamping jaws is carried out independently of the stack thickness.

8. An apparatus according to claim 1, wherein the first and second clamping jaws are mounted so that they float in order to compensate variations in thickness within the stack of sheet-shaped materials.

9. An apparatus according to claim 1, wherein the axis of rotation lies in the center of the stack.

10. An apparatus according to claim 1, wherein the clamp drive is operable by hand.

11. A method for securing sheet-shaped materials during a rotary movement, whereby the rotation occurs around an axis of rotation (M) that is parallel to the outside edges of the sheet-shaped materials comprising the steps of:
driving first and a second movable clamping jaws to clamp the sheet-shaped materials;
rotating the clamped stack of sheet-shaped materials around the axis of rotation (M), which is on the centerline of the clamped stack of sheet-shaped materials.

12. A method according to claim 11, wherein driving of the first and a second movable clamping jaws is carried out symmetrical to the stack of sheet-shaped materials.

13. A method according to claim 11, wherein the stack of sheet-shaped materials is arranged vertically while being clamped.

14. A method according to claim 11, wherein the driving does not move the first and a second movable clamping jaws during the rotation.

15. A method according to claim 11, wherein the first and a second movable clamping jaws are closed on both sides.

16. A method according to claim 11, wherein the driving comprises driving two worm gears that translate rotary movement of the clamp drive into a linear movement.

17. A method according to claim 11, wherein the clamping is carried out independently of the stack thickness.

18. A method according to claim 11, wherein the first and second clamping jaws are mounted so that they float in order to compensate variations in thickness within the stack of sheet-shaped materials.

19. A method according to claim 11, wherein the axis of rotation lies in the center of the stack.

20. A method according to claim 11, wherein driving comprising operating by hand.
